(19) United States
(12) Patent Application Publication
(10) Pub. No.: US 2026/0213676 A1
(43) Pub. Date: Jul. 23, 2026

(54) POWER CONVERSION DEVICE AND METHOD FOR CONTROLLING POWER CONVERSION DEVICE

(71) Applicant: Mitsubishi Electric Corporation, Tokyo (JP)

(72) Inventor: Tetsuya KOJIMA, Tokyo (JP)

(73) Assignee: Mitsubishi Electric Corporation, Tokyo (JP)

(21) Appl. No.: 19/138,679

(22) PCT Filed: Feb. 1, 2023
(86) PCT No.: PCT/JP2023/003220

§ 371 Date: Jun. 13, 2025

(51) Int. Cl. H02M 7/539; H02M 1/12; H02M 7/483

(52) U.S. Cl. CPC H02M 7/539; H02M 1/12; H02M 7/483

(57) ABSTRACT

A power conversion device that supplies power to a multiphase load based on a first command value includes: a multiphase inverter circuit in which legs including two series-connected semiconductor switching elements are connected in parallel between positive and negative terminals of a DC power supply; a modulation voltage generator that generates a second command value including a fundamental wave component of the first command value and a harmonic component including at least one sine wave having a frequency that is an odd multiple of the fundamental wave component; a carrier signal generator that generates a carrier signal of a triangular wave having a frequency that is an odd multiple of the fundamental wave component; and a gate signal generator that generates a gate signal for driving the semiconductor switching elements in accordance with a result of comparison between the second command value and the carrier signal.

### FIELD

The present disclosure relates to a power conversion device that converts DC power into AC power, and a method for controlling the power conversion device.

### BACKGROUND

Inverters are widely used as power conversion devices that convert DC power into AC power. An inverter compares a sinusoidal modulation signal with a triangular carrier signal, turns on and off semiconductor switching elements, and outputs a sinusoidal phase voltage. However, harmonics are generated in the phase voltage by switching. For example, given that the frequency of the phase voltage is fₛ and the frequency of the carrier signal is f_{c}, harmonics of a frequency component A having a frequency of fc±2fₛ and a frequency component B having a frequency of f_{c}±4fₛ are generated in the phase voltage. Harmonics increase load losses and cause noise and torque pulsation.

In the technique disclosed in Patent Literature 1, a harmonic component is superimposed on a sinusoidal modulation signal to disperse a ratio between the frequency component A and the frequency component B included in the phase voltage. Patent Literature 1 describes that load loss can be reduced by dispersing the ratio between the frequency component A and the frequency component B included in the phase voltage.

### CITATION LIST

### Patent Literature

Patent Literature 1: Japanese Patent Application Laid-open No. 2014-072935

### SUMMARY OF INVENTION

### Problem to be Solved by the Invention

However, according to the above-described related-art technique, when the frequency of the noise or the torque pulsation generated by the frequency component A is the same as the frequency of the noise or the torque pulsation generated by the frequency component B, there is a problem that the noise and the torque pulsation cannot be reduced by dispersing the ratio between the frequency component A and the frequency component B.

For example, given that the number of phases of the inverter is three and f_{c}=9f_{z}, the frequency of the frequency component A is 7fₛ and 11fₛ, and the frequency of the frequency component B is 5fₛ and 13fₛ. Considering the frequency of the noise and the torque pulsation generated by the frequency component A, it is 6f_{z} since 7fₛ is a positive phase component, and is 12fₛ since 11fₛ is a negative phase component. Similarly, considering the frequency of the noise and the torque pulsation generated by the frequency component B, it is 6fₛ since 5fₛ is a positive phase component, and is 12fₛ since 13fₛ is a negative phase component. That is, in the above case, even if the ratio between the frequency component A and the frequency component B is dispersed, noise and torque pulsation of frequencies common to both components are generated, and thus, it is not possible to reduce the noise and the torque pulsation.

The present disclosure has been made in view of the above, and an object thereof is to obtain a power conversion device capable of effectively reducing noise and torque pulsation generated by switching of an inverter and reducing a loss of a load due to harmonic components.

### Means to Solve the Problem

To solve the problem and achieve the object, the present disclosure provides a power conversion device to supply power to a multiphase load based on a first command value, the first command value being a sinusoidal phase voltage command value, the power conversion device comprising: a multiphase inverter circuit in which legs each including two series-connected semiconductor switching elements having reverse conduction functions are connected in parallel between positive and negative terminals of a DC power supply, the number of the legs being equal to the number of phases, and a terminal between the two semiconductor switching elements in each of the plurality of legs is connected to each phase of the load; a modulation voltage generator to generate a second command value, the second command value being a phase voltage command value for modulation and including a fundamental wave component of the first command value and a harmonic component including at least one sine wave having a frequency that is an odd multiple of the fundamental wave component; a carrier signal generator to generate a carrier signal of a triangular wave having a frequency that is an odd multiple of the fundamental wave component of the first command value, the triangular wave having a median value synchronized with a phase zero of the fundamental wave component of the first command value; and a gate signal generator to generate a gate signal for driving the semiconductor switching elements in accordance with a result of comparison between the second command value and the carrier signal.

### Effects of the Invention

The present disclosure can achieve the effect of effectively reducing noise and torque pulsation generated by switching of an inverter and reducing a loss of a load due to harmonic components.

### BRIEF DESCRIPTION OF DRAWINGS

FIG. 1 is a diagram illustrating a configuration of a power conversion device according to the first embodiment.

FIG. 2 is a diagram illustrating a configuration of the carrier signal generator illustrated in FIG. 1.

FIG. 3 is a diagram illustrating a carrier signal generated by the carrier signal calculator illustrated in FIG. 2.

FIG. 4 is a diagram illustrating an example of the carrier signal c generated by the carrier signal calculator illustrated in FIG. 2.

FIG. 5 is a diagram for explaining the operation of the gate signal generator illustrated in FIG. 1.

FIG. 6 is a diagram illustrating an example of the phase voltage output from the power conversion device when the sinusoidal second command value is provided to the gate signal generator.

FIG. 7 is a diagram illustrating a configuration of the modulation voltage generator illustrated in FIG. 1.

FIG. 8 is a diagram illustrating waveforms of the second command values, the carrier signal, and the output phase voltage according to the first embodiment.

FIG. 9 is a diagram illustrating waveforms of the phase voltage command value, the carrier signal, and the output phase voltage according to a comparative example of the first embodiment.

FIG. 10 is a diagram illustrating the WTHD of the power conversion device according to the first embodiment.

FIG. 11 is a diagram illustrating WTHD in a comparative example of the first embodiment.

FIG. 12 is a diagram illustrating the magnitude of harmonic components included in the output phase voltage of the power conversion device according to the first embodiment.

FIG. 13 is a diagram illustrating the magnitude of harmonic components included in the output phase voltage in a comparative example of the first embodiment.

FIG. 14 is a diagram illustrating a configuration of a power conversion device according to the second embodiment.

FIG. 15 is a diagram illustrating a configuration of the modulation voltage generator illustrated in FIG. 14.

FIG. 16 is a diagram illustrating a configuration of a power conversion device according to the third embodiment.

FIG. 17 is a diagram illustrating a configuration of the carrier signal generator illustrated in FIG. 16.

FIG. 18 is a diagram illustrating a configuration of the modulation voltage generator illustrated in FIG. 16.

FIG. 19 is a diagram illustrating waveforms of the second command values, the carrier signal c, and the output phase voltage according to the third embodiment.

FIG. 20 is a diagram illustrating waveforms of the phase voltage command value, the carrier signal, and the output phase voltage according to a comparative example of the third embodiment.

FIG. 21 is a diagram illustrating the WTHD of the power conversion device according to the third embodiment.

FIG. 22 is a diagram illustrating the WTHD in a comparative example of the third embodiment.

FIG. 23 is a diagram illustrating the magnitude of harmonic components included in the output phase voltage of the power conversion device according to the third embodiment.

FIG. 24 is a diagram illustrating the magnitude of harmonic components included in the output phase voltage in a comparative example of the third embodiment.

FIG. 25 is a diagram illustrating an exemplary configuration of the power conversion device using dedicated hardware.

FIG. 26 is a diagram illustrating an exemplary configuration of the power conversion device using a processor and a storage device.

### DESCRIPTION OF EMBODIMENTS

Hereinafter, a power conversion device and a method for controlling the power conversion device according to embodiments of the present disclosure will be described in detail with reference to the drawings.

### First Embodiment

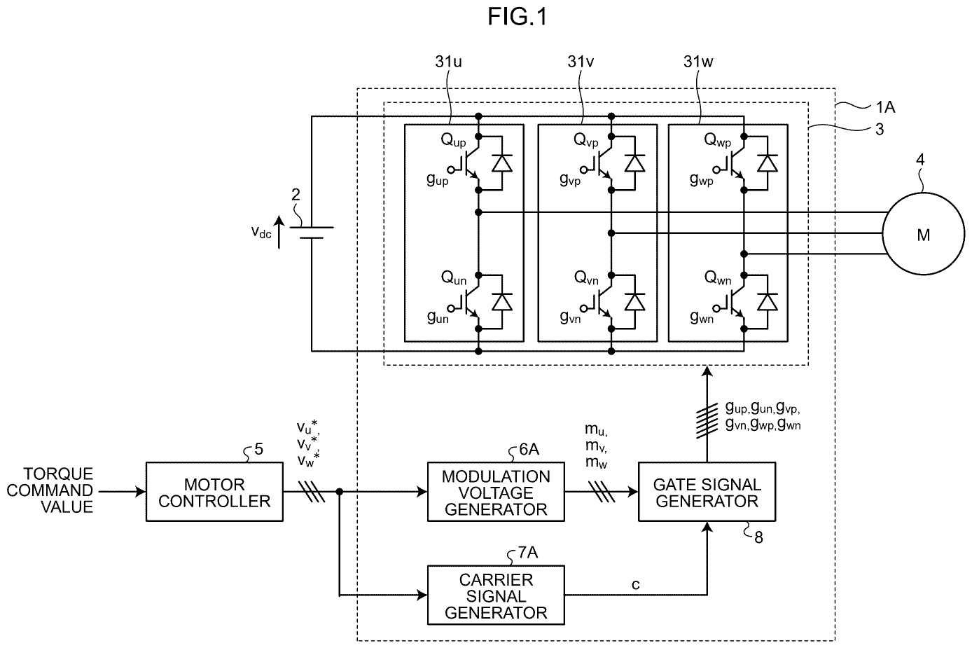

FIG. 1 is a diagram illustrating a configuration of a power conversion device 1A according to the first embodiment. The power conversion device 1A includes a multiphase inverter circuit 3 connected to each of a DC power supply 2 and a motor 4 as a load, a modulation voltage generator 6A, a carrier signal generator 7A, and a gate signal generator 8.

The multiphase inverter circuit 3 converts DC power of the DC power supply 2 into multiphase AC power and outputs the multiphase AC power to the motor 4. Here, the number of phases of the multiphase inverter circuit 3 is three, which are a u phase, a v phase, and a w phase. The multiphase inverter circuit 3 includes legs 31 each including two series-connected semiconductor switching elements Q having reverse conduction functions, the legs 31 being connected in parallel, the number of the legs 31 being equal to the number of phases. Since the number of phases of the multiphase inverter circuit 3 is three, the multiphase inverter circuit 3 includes six semiconductor switching elements Q, and as illustrated in FIG. 1, the six semiconductor switching elements Q are referred to as semiconductor switching elements Qᵤₚ, Qᵤₙ, Qᵥₚ, Qᵥₙ, Q_{wp}, and Q_{wn}. A series connection of the positive semiconductor switching element Qᵤₚ and the negative semiconductor switching element Qᵤₙ corresponding to the u phase is referred to as a leg 31u, a series connection of the positive semiconductor switching element Qᵥₚ and the negative semiconductor switching element Qᵥₙ corresponding to the v phase is referred to as a leg 31v, and a series connection of the positive semiconductor switching element Q_{wp} and the negative semiconductor switching element Q_{wn} corresponding to the w phase is referred to as a leg 31w. An intermediate terminal of each leg 31 is connected to the corresponding phase of the motor 4. Here, each semiconductor switching element Q is configured by an insulated gate bipolar transistor (IGBT) and an anti-parallel diode. If a metal-oxide-semiconductor field-effect transistor (MOSFET), a reverse conducting (RC)-IGBT, or the like is used instead of the IGBT, the anti-parallel diode may be omitted.

A motor controller 5 calculates first command values vᵤ⁺, vᵥ⁺, and v_{w}⁺, which are sinusoidal phase voltage command values, as voltages to be supplied to the motor 4 from the torque command value of the motor 4. The motor controller 5 outputs the calculated first command values vᵤ⁺, vᵥ⁺, and v_{w}⁺ to the modulation voltage generator 6A and the carrier signal generator 7A.

The modulation voltage generator 6A generates second command values mᵤ, mᵥ, and m_{w}, which are phase voltage command values for modulation, based on the first command values vᵤ⁺, vᵥ⁺, and v_{w}⁺. The modulation voltage generator 6A outputs the generated second command values mᵤ, mᵥ, and m_{w} to the gate signal generator 8. In addition, the carrier signal generator 7A generates a triangular wave carrier signal c based on the first command values vᵤ⁺, vᵥ⁺, and v_{w}⁺. The carrier signal generator 7A outputs the generated carrier signal c to the gate signal generator 8. The gate signal generator 8 compares the magnitudes of the second command values mᵤ, mᵥ, and m_{w} with the magnitude of the carrier signal c to generate gate signals gᵤₚ, gᵤₙ, gᵥₚ, gᵥₙ, g_{wp}, and g_{wn} for controlling on and off of the semiconductor switching element Q of the multiphase inverter circuit 3. The gate signals gᵤₚ, gᵤₙ, gᵥₚ, gᵥₙ, g_{wp}, and g_{wn} respectively correspond to the semiconductor switching elements Qᵤₚ, Qᵤₙ, Qᵥₚ, Qᵥₙ, Q_{wp}, and Q_{wn}, and turn on or off the corresponding semiconductor switching elements Q. Note that the gate signals gᵤₚ, gᵤₙ, gᵥₚ, gᵥₙ, g_{wp}, and g_{wn} are simply referred to as gate signals g when not distinguished from one another.

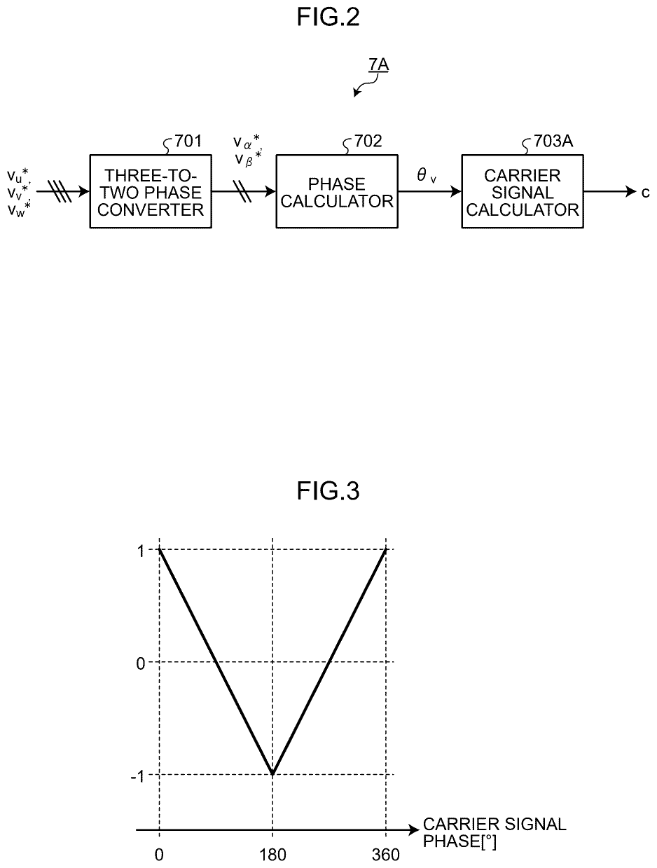

FIG. 2 is a diagram illustrating a configuration of the carrier signal generator 7A illustrated in FIG. 1. The carrier signal generator 7A includes a three-to-two phase converter 701, a phase calculator 702, and a carrier signal calculator 703A.

The three-to-two phase converter 701 performs three-to-two phase conversion on the first command values vᵤ⁺, vᵥ⁺, and v_{w}⁺ on the three-phase coordinates into first command values v_{α}⁺ and v_{β}⁺ on the two-phase coordinates. The three-to-two phase converter 701 can perform three-to-two phase conversion using, for example, Formula (1) below.

$$Formula 1$$

$$[ \begin{matrix}{v}_{α}^{*} \\ {v}_{β}^{*}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{v}_{u}^{*} \\ {v}_{v}^{*} \\ {v}_{w}^{*}\end{matrix} ] \qquad ( 1 )$$

The phase calculator 702 calculates a fundamental wave phase θᵥ of the u-phase of the first command values v_{α}⁺ and v_{β}⁺ on the two-phase coordinates. Specifically, first, an arc tangent calculation is performed on the first command values v_{α}⁺ and v_{β}⁺ on the two-phase coordinates to obtain the phase of v_{α}⁺. This phase is the same as the phase of vᵤ⁺. However, since the phase of v_{α}⁺ obtained by performing the arc tangent calculation on the first command values v_{α}⁺ and v_{β}⁺ on the two-phase coordinates is based on the cos signal, the phase based on the sin signal can be obtained by subtracting “π/2” from this phase.

Here, the first command values vᵤ⁺, vᵥ⁺, and v_{w}⁺ and the first command values v_{α}⁺ and v_{β}⁺ are described on the assumption that the first command values vᵤ⁺, vᵥ⁺, and v_{w}⁺ have waveforms with sufficiently few harmonic components and are the same as the fundamental wave components. When the response of the motor controller 5 is fast and many harmonic components are included in the first command values vᵤ⁺, vᵥ⁺, and v_{w}⁺ and the first command values v_{α}⁺ and v_{β}⁺, the fundamental wave component can be extracted by passing through a low-pass filter or the like.

The carrier signal calculator 703A first calculates a carrier signal c having a frequency of an odd number Kc times the fundamental wave component. Specifically, the phase of the carrier signal is generated by multiplying the fundamental wave phase θv by the odd number Kc. Then, the carrier signal calculator 703A generates a triangular wave carrier signal c as illustrated in FIG. 3. FIG. 3 is a diagram illustrating a carrier signal generated by the carrier signal calculator 703A illustrated in FIG. 2. Further, the carrier signal calculator 703A performs phase synchronization control of correcting the phase of the carrier signal c so that the median value of the triangular wave overlaps the phase of 0° of the phase voltage command value. In the example illustrated in FIG. 3, the median value of the triangle wave is zero. The carrier signal calculator 703A outputs the carrier signal c subjected to the phase synchronization control to the gate signal generator 8.

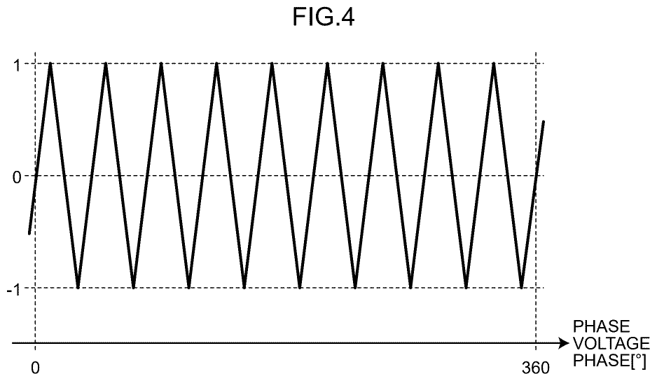

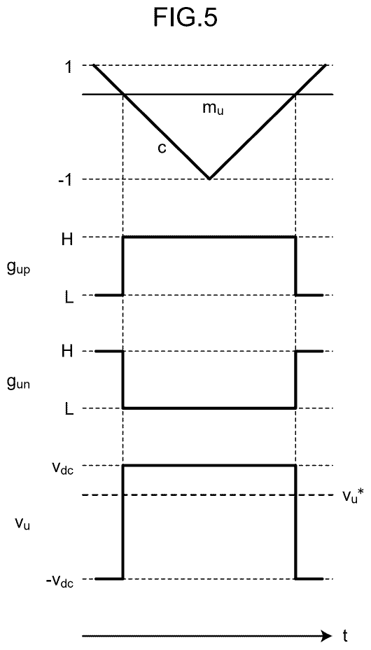

In the present embodiment, the odd number Kc is set to nine, and the phase of 270° of the carrier signal c is synchronized with the phase of 0° of the phase voltage command value. At this time, the carrier signal is as illustrated in FIG. 4. FIG. 4 is a diagram illustrating an example of the carrier signal c generated by the carrier signal calculator 703A illustrated in FIG. 2. In the present embodiment, the carrier signal c is synchronized with the phase of the u-phase voltage, and the carrier signal c common to the three phases is used. Therefore, the odd number Kc for determining the frequency of the carrier signal c is set to a multiple of three, the number of phases.

Returning to FIG. 1, the gate signal generator 8 compares each of the second command values mᵤ, mᵥ, and m_{w}, which are phase voltage command values for modulation output from the modulation voltage generator 6A, with the carrier signal c, and generates the gate signals gᵤₚ, gᵤₙ, gᵥₚ, gᵥₙ, g_{wp}, and g_{wn} for controlling on and off of the semiconductor switching elements Qᵤₚ, Qᵤₙ, Qᵥₚ, Qᵥₙ, Q_{wp}, and Q_{wn} of the multiphase inverter circuit 3. Each of the gate signals gᵤₚ, gᵤₙ, gᵥₚ, gᵥₙ, g_{wp}, and g_{wn} takes a value of high “H” or low “L”. When the value of the gate signal g is “H”, the semiconductor switching element Q corresponding to the gate signal g is controlled to be turned on, and when the value of the gate signal g is “L”, the semiconductor switching element Q corresponding to the gate signal g is controlled to be turned off.

FIG. 5 is a diagram for explaining the operation of the gate signal generator 8 illustrated in FIG. 1. FIG. 5 illustrates the u-phase component. The gate signal generator 8 compares the second command value mᵤ with the carrier signal c to generate the gate signals gᵤₚ and gᵤₙ. Specifically, here, when the second command value mᵤ is larger than the carrier signal c, the value of the gate signal gᵤₚ is “H” and the value of the gate signal gᵤₙ is “L”, and when the second command value mᵤ is smaller than the carrier signal c, the value of the gate signal gᵤₚ is “L” and the value of the gate signal gᵤₙ is “H”. The gate signals gᵤₚ and gᵤₙ are complementary to each other. That is, when the gate signal gᵤₚ is “H”, the gate signal gᵤₙ is “L”, and when the gate signal gᵤₚ is “L”, the gate signal gᵤₙ is “H”. When the gate signal gᵤₚ is “H”, the positive-side semiconductor switching element Qᵤₚ is turned on and the output phase voltage vᵤ is v_{dc}/2, and when the gate signal gᵤₙ is “H”, the negative-side semiconductor switching element Qᵤₙ is turned on and the output voltage vᵤ is −v_{dc}/2. By averaging the output phase voltage vᵤ by the cycle of the carrier signal c, a phase voltage according to the first command value vᵤ⁺ is obtained.

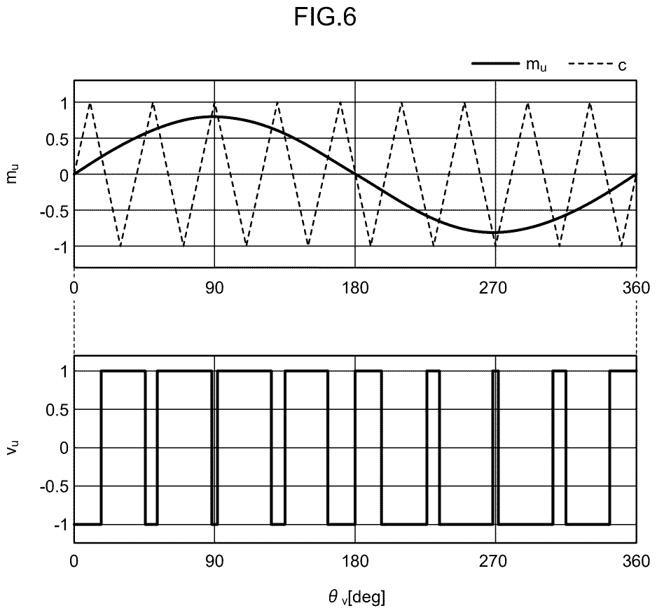

Here, consider the second command values mᵤ, mᵥ, and m_{w} generated by the modulation voltage generator 6A by considering harmonic components assumed to be generated when the carrier signal c generated by the carrier signal generator 7A and the gate signal generator 8 described above are used. FIG. 6 is a diagram illustrating an example of the phase voltage output from the power conversion device 1A when the sinusoidal second command value mᵤ is provided to the gate signal generator 8. FIG. 6 illustrates, for the u-phase, the waveform of the phase voltage output when the multiphase inverter circuit 3 is operated by generating the gate signal g from the second command values mᵤ, mᵥ, and m_{w}, which are sinusoidal phase voltage command values for modulation, using the carrier signal c and the gate signal generator 8. The upper part of FIG. 6 illustrates the sinusoidal second command value mᵤ and the triangular wave carrier signal c, and the lower part of FIG. 6 illustrates the output phase voltage vᵤ output based on the sinusoidal second command value mᵤ and the triangular wave carrier signal c. The waveform of the output phase voltage vᵤ output from the power conversion device 1A is expressed by the sum of sine wave components and cosine wave components of various orders based on the idea of Fourier series expansion. Here, since the phase voltage is positively and negatively symmetric in the phases of 0° to 180° and phases of 180° to 360°, even-order harmonic components are first removed. Next, the phase voltage is inverted between phases of 0° to 90° and phases of 900 to 180°, and the cosine wave component is also removed. Therefore, when the carrier signal c of the present embodiment is used, the harmonic component of the phase voltage is only the odd-order sine wave component. Further, based on this result, optimization of the phase voltage waveform by superimposing harmonic components on the first command values vᵤ⁺, vᵥ⁺, and v_{w}⁺ or the second command values mᵤ, mᵥ, and m_{w} can be performed simply by superimposing odd-order sine wave components on the first command values vᵤ⁺, vᵥ⁺, and v_{w}⁺ or the second command values mᵤ, mᵥ, and m_{w}.

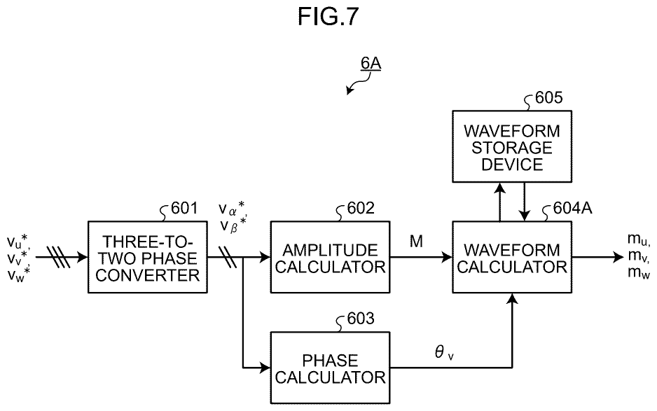

FIG. 7 is a diagram illustrating a configuration of the modulation voltage generator 6A illustrated in FIG. 1. The modulation voltage generator 6A includes a three-to-two phase converter 601, an amplitude calculator 602, a phase calculator 603, a waveform calculator 604A, and a waveform storage device 605.

The three-to-two phase converter 601 performs three-to-two phase conversion on the first command values vᵤ⁺, vᵥ⁺, and v_{w}⁺, which are sinusoidal phase voltage command values on the three-phase coordinates, into the first command values v_{α}⁺ and v_{β}⁺ on the two-phase coordinates by processing similar to that of the three-to-two phase converter 701. The three-to-two phase converter 601 outputs the first command values v_{α}⁺ and v_{β}⁺ on the two-phase coordinates to the amplitude calculator 602 and the phase calculator 603.

The amplitude calculator 602 first calculates the amplitudes vₚₕₚ of the first command values v_{α}⁺, and v_{β}⁺ from the first command values v_{α}⁺ and v_{β}⁺ on the two-phase coordinates. For example, the amplitude calculator 602 can calculate the amplitude vₚₕₚ of the first command values v_{α}⁺ and v_{β}⁺ using Formula (2) below.

$$Formula 2$$

$${v}_{php} = \sqrt{\frac{2}{3}} \sqrt{{v}_{α}^{*} + {v}_{β}^{*}} \qquad ( 2 )$$

Next, as shown in Formula (3) below, the amplitude calculator 602 divides the amplitude vₚₕₚ of the calculated first command values v_{α}⁺ and v_{β}⁺ by ½ of the DC voltage to convert it into the amplitude M of the second command values mᵤ, mᵥ, and m_{w} which are voltage command values for modulation. The amplitude calculator 602 outputs the amplitude M, which is the calculation result, to the waveform calculator 604A.

$$Formula 3$$

$$M = \frac{{v}_{php}}{{v}_{d c} / 2} \qquad ( 3 )$$

The phase calculator 603 calculates the u-phase fundamental wave phase θᵥ of the first command values v_{α}⁺ and v_{β}⁺ on the two-phase coordinates by processing similar to that of the phase calculator 702. The phase calculator 603 outputs the fundamental wave phase θᵥ, which is the calculation result, to the waveform calculator 604A.

The waveform calculator 604A calculates the waveforms of the second command values mᵤ, mᵥ, and m_{w} using the amplitude M and the u-phase fundamental wave phase θᵥ. Specifically, the waveforms of the second command values mᵤ, mᵥ, and m_{w} corresponding to ¼ cycles of the phases of 0° to 90° of the fundamental waves of the first command values vᵤ⁺, vᵥ⁺ and v_{w}⁺ are stored in advance in the waveform storage device 605, and the second command values mᵤ, mᵥ, and m_{w} are generated using the stored waveforms. Here, the waveform calculator 604A reproduces the waveform of one period of the fundamental wave from the waveform corresponding to ¼ cycles of the fundamental wave using the phase voltage, that is, the second command values mᵤ, mᵥ, and m_{w}, which are positively and negatively symmetric in the phases of 0° to 180° and 180° to 360° and inverted symmetric in the phases of 0° to 900 and 900 to 180°. Since the waveforms of the three-phase modulation phase voltage command values are waveforms whose phases are shifted from each other by 120°, the waveform calculator 604A can generate the u-phase waveform using the u-phase fundamental wave phase θᵥ and then shift the phases to generate the three-phase second command values mᵤ, mᵥ, and m_{w}.

The waveforms of the second command values mᵤ, mᵥ, and m_{w} stored in the waveform storage device 605 are generated such that, when the carrier signal c generated by the carrier signal generator 7A is used in the present embodiment, the fundamental wave component of the phase voltage matches the command value and the harmonic component is optimized. Here, in the present embodiment, the optimal second command values mᵤ, mᵥ, and m_{w} can be obtained with a simple method in which only odd-order sine wave components as harmonic components are superimposed on the fundamental wave components of the first command values vᵤ⁺, vᵥ⁺, and v_{w}⁺.

As a method of superimposing a harmonic component on a phase voltage command value, WO 2019/016901 A discloses a method of superimposing a third harmonic for a three-phase inverter circuit. In this method, by superimposing harmonics whose frequency is an integral multiple of the number of phases, a larger AC voltage can be supplied to the load effectively using the voltage on the DC side without changing the output voltage on the load side of the multiphase inverter circuit 3. On the other hand, in the present embodiment, a harmonic component whose frequency is not an integral multiple of the number of phases, that is, a sine wave, is also superimposed on the phase voltage command value. As a result, the frequency distribution of the harmonic components generated by the switching of the multiphase inverter circuit 3 can be optimized.

In addition, in the present embodiment, the second command values mᵤ, mᵥ, and m_{w} are constant values in the carrier half cycle that is a period in which the carrier signal c changes from the minimum value to the maximum value or a period in which the carrier signal c changes from the maximum value to the minimum value. In the present embodiment, since the odd number Kc is set to nine, the fundamental wave ¼ cycle stored in the waveform storage device 605 corresponds to 4.5 times the carrier half cycle, but in order to maintain the symmetry of the phase voltage waveform, the second command values mᵤ, mᵥ, and m_{w} are set to zero in the first 0.5 cycles. Therefore, in the present embodiment, it is sufficient to optimize and store only four values corresponding to four sections of the carrier half cycle, and the optimization is easy.

Note that, although the waveforms for the fundamental wave ¼ cycle of the second command values mᵤ, mᵥ, and m_{w} for one phase are stored here, in a case where waveforms for a plurality of phases are stored, the storage period can be reduced. When the number of phases is three, the phase of the v-phase voltage is −120° to −90°, that is, 240° to 270° during a period in which the phase of the u-phase voltage is 0° to 30°. This waveform is obtained by positive and negative inversion of the waveform in the period of 60° to 90° of the u-phase voltage in consideration of the symmetry of the waveform. Next, during the period in which the phase of the u-phase voltage is 0° to 30°, the phase of the w-phase voltage is −240° to −210°, that is, 120° to 150°. In consideration of the symmetry of the waveform, this waveform is obtained by inverting the waveform in the period of 30° to 60° of the u-phase voltage in the time direction, that is, the phase direction. Therefore, in a case where the waveforms of the second command values mᵤ, mᵥ, and m_{w} for the three phases are stored, if the waveforms for the period of the phase of 0° to 30° are stored, the waveforms for the period of 0° to 90° can be reproduced. That is, the waveforms of the second command values mᵤ, mᵥ, and m_{w} for multiple phases can be stored simply by storing the waveforms for a period obtained by dividing a period of 90°, which is the fundamental wave ¼ cycle, by the number of phases.

In the present embodiment, the harmonic component of the phase voltage is optimized so as to minimize an objective function f_{obj} expressed by Formula (4) below.

$$Formula 4$$

$${f}_{obj} = \sqrt{{\sum }_{i = 1}^{8} \{ {( {k}_{6 i - 1} \frac{{v}_{6 i - 1}}{6 i - 1} )}^{2} + {( {k}_{6 i + 1} \frac{{v}_{6 i + 1}}{6 i + 1} )}^{2} \}} \qquad ( 4 )$$

Here, the harmonic component is optimized so that the square root of the sum of squares of the value obtained by dividing the n-th harmonic voltage vn by the order n, that is, the effective current value of the load, is minimized. Here, n=6i±1. However, it is assumed that specific frequency components, here, fifth and seventh harmonic components, excite mechanical resonance of a load to cause large noise and torque pulsation, and weighting of these order components is increased to preferentially reduce the frequency components. That is, as expressed by Formula (5) below, the weight kₙ in Formula (4) is larger when n is five and when n is seven than when n is other than five and seven. This makes it possible to reduce load loss while reducing noise and torque pulsation.

$$Formula 5$$

$${k}_{n} = \{ \begin{matrix}1 & ( n \neq 5 , 7 ) \\ 10 & ( n = 5 , 7 )\end{matrix} \qquad ( 5 )$$

In the present embodiment, the number of phases of the multiphase inverter circuit 3 and the motor 4 is set to three, and the three-phase waveforms are waveforms whose phases are shifted from each other by 120°, so that a harmonic component of a multiple of three is not generated. Furthermore, since the voltage waveform of each phase is positively and negatively symmetric in the phases of 0° to 180° and the phases of 180° to 360°, a harmonic component of a multiple of two is also not generated. In the optimization, harmonic components are considered up to the 50th order.

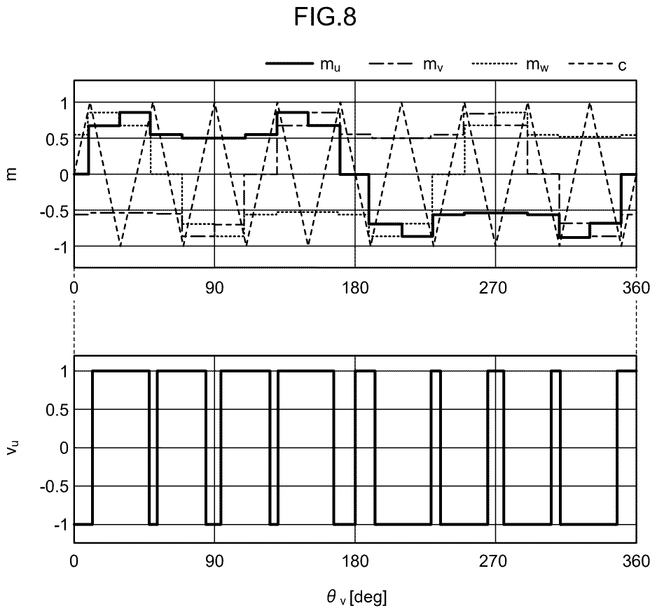

FIG. 8 is a diagram illustrating waveforms of the second command values mᵤ, mᵥ, and m_{w}, the carrier signal c, and the output phase voltage vᵤ according to the first embodiment. FIG. 8 illustrates a case where the amplitude M=0.8. The second command values mᵤ, mᵥ, and m_{w} include fundamental wave components of the first command values vᵤ⁺, vᵥ⁺, and v_{w}⁺ and harmonic components including odd-order sine wave components. Here, the harmonic component includes a sine wave component whose frequency is not an integral multiple of the number of phases. Specifically, sine wave components having frequencies that are 3 times, 5 times, 7 times, 11 times, 13 times, 15 times, 17 times, 19 times, and 21 times the fundamental wave component are superimposed on the second command values mᵤ, mᵥ, and m_{w}. Although the sine wave components having frequencies up to 21 times the fundamental wave component are described here, a sine wave component having a higher frequency is superimposed on the second command values mᵤ, mᵥ, and m_{w}. The output phase voltage vᵤ of the u phase is positively and negatively symmetric in the phases of 0° to 180° and phases of 180° to 360°, and is inversely symmetric in the phases of 0° to 90° and phases of 90° to 180°. In addition, the second command values mᵤ, mᵥ, and m_{w} are constant values in the carrier half cycle.

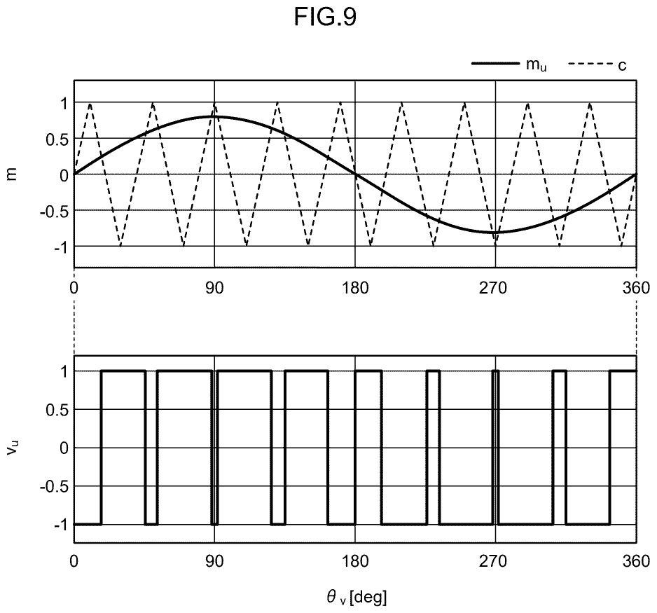

Here, in order to describe the effect of the power conversion device 1A according to the present embodiment, a comparative example using general carrier synchronization pulse width modulation (PWM) will be described. FIG. 9 is a diagram illustrating waveforms of the phase voltage command value, the carrier signal c, and the output phase voltage vᵤ according to a comparative example of the first embodiment. The difference from the example of the first embodiment illustrated in FIG. 8 is that no harmonic component is superimposed on the phase voltage command value. The same carrier signal c as that in the example illustrated in FIG. 8 is used.

Here, the effective current value of the motor 4 as a load is evaluated by WTHD expressed by Formula (6) below.

$$Formula 6$$

$$WTHD = \frac{\sqrt{{\sum }_{n = 2}^{∞} {( \frac{{v}_{n}}{n} )}^{2}}}{{v}_{1}} \qquad ( 6 )$$

The numerator of Formula (6) is the square root of the sum of squares of a value obtained by dividing the n-th harmonic voltage vn by its order n, that is, a value corresponding to the effective current value of the load. By dividing this effective current value by the amplitude v1 of the fundamental wave voltage of the denominator, WTHD becomes a value corresponding to the current distortion rate.

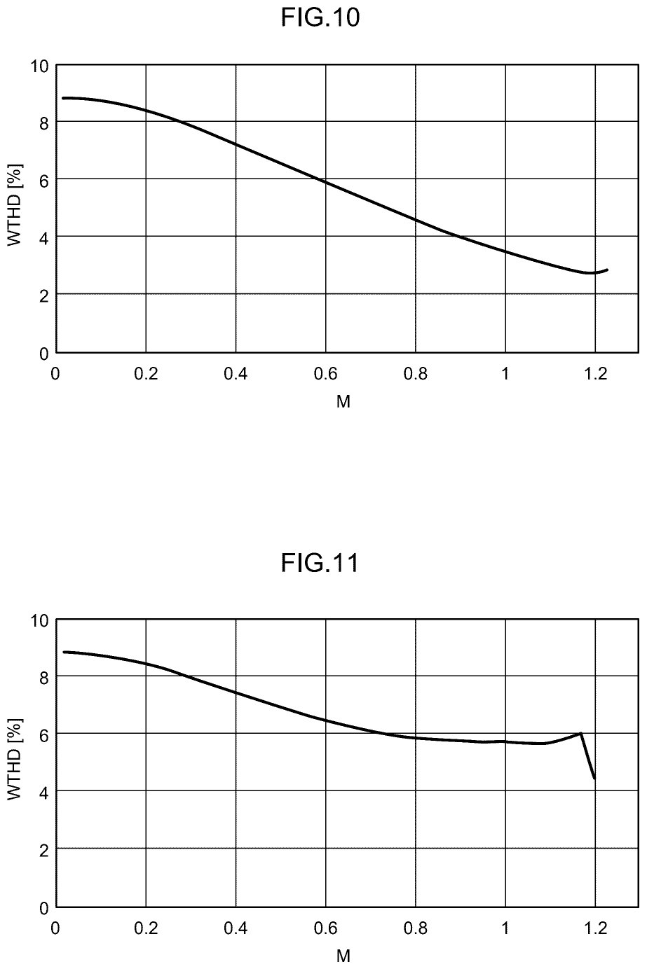

Here, the value of WTHD is compared between the power conversion device 1A according to the present embodiment and the comparative example. FIG. 10 is a diagram illustrating the WTHD of the power conversion device 1A according to the first embodiment. FIG. 11 is a diagram illustrating WTHD in a comparative example of the first embodiment. Comparing FIG. 10 with FIG. 11, it can be confirmed that WTHD can be greatly reduced particularly in a region where the amplitude M of the modulation voltage is large, and the effective current value of the load, that is, the loss can be reduced.

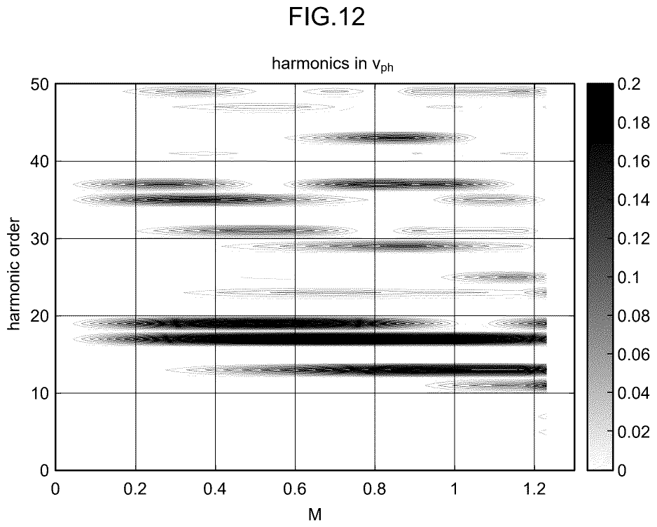

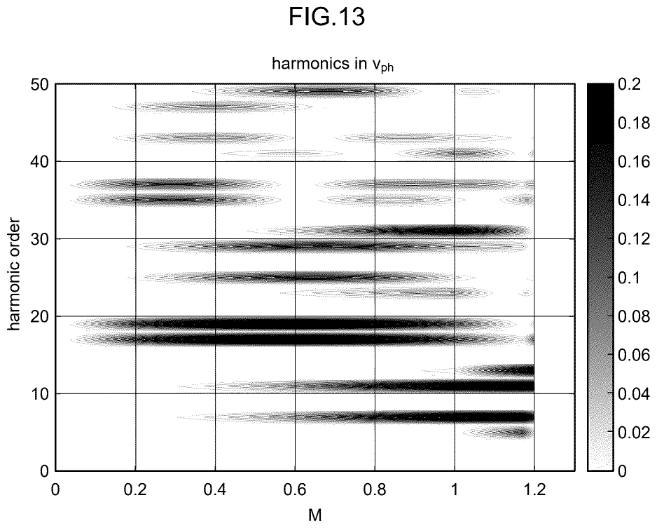

In addition, harmonic components included in the output phase voltage are compared between the power conversion device 1A according to the present embodiment and the comparative example. FIG. 12 is a diagram illustrating the magnitude of harmonic components included in the output phase voltage of the power conversion device 1A according to the first embodiment. FIG. 13 is a diagram illustrating the magnitude of harmonic components included in the output phase voltage in a comparative example of the first embodiment. In FIGS. 12 and 13, the horizontal axis represents the amplitude M, and the vertical axis represents the frequency of the harmonic wave and is expressed by the order with respect to the fundamental wave. In FIGS. 12 and 13, for the magnitude of the harmonic components, a value obtained by dividing the amplitude vₚₕ of the output phase voltage by half of the DC voltage is indicated by color shading. By comparing FIGS. 12 and 13, it can be seen that in the power conversion device 1A according to the present embodiment, it is possible to greatly reduce specific frequency components assumed to excite mechanical resonance of the load to cause large noise and torque pulsation, here, the fifth and seventh harmonic components. The amplitudes of the fifth and seventh harmonic components are several percent or less of the amplitude M which is the amplitude of the fundamental wave component, and it can be confirmed that the amplitudes are almost removed.

As described above, the power conversion device 1A according to the first embodiment supplies power to the motor 4, which is a multiphase load, based on the first command values vᵤ⁺, vᵥ⁺, and v_{w}⁺. The first command values vᵤ⁺, vᵥ⁺, and v_{w}⁺ are sinusoidal phase voltage command values. The power conversion device 1A includes: the multiphase inverter circuit 3 in which the legs 31 including two series-connected semiconductor switching elements Q having reverse conduction functions are connected in parallel between positive and negative terminals of the DC power supply 2, the number of the legs 31 being equal to the number of phases, and a terminal between the two semiconductor switching elements Q in each of the plurality of legs 31 is connected to each phase of the motor 4 that is a load; the modulation voltage generator 6A that generates the second command values mᵤ, mᵥ, and m_{w}, the second command values mᵤ, mᵥ, and m_{w} being phase voltage command values for modulation and including a fundamental wave component of the first command values vᵤ⁺, vᵥ⁺, and v_{w}⁺, and a harmonic component including at least one sine wave having a frequency of an odd multiple of the fundamental wave component; the carrier signal generator 7A that generates the carrier signal c of a triangular wave having a frequency that is an odd multiple of the fundamental wave component of the first command values vᵤ⁺, vᵥ⁺, and v_{w}⁺ the triangular wave having a median value synchronized with a phase zero of the fundamental wave component of the first command values vᵤ⁺, vᵥ⁺, and v_{w}⁺; and the gate signal generator 8 that generates the gate signal g for driving each of the plurality of semiconductor switching elements Q of the multiphase inverter circuit 3 in accordance with a result of comparison between the second command values mᵤ, mᵥ, and m_{w} and the carrier signal c.

Because of the feature that the carrier signal c of a triangular wave is such that the frequency is an odd multiple of the fundamental wave component of the first command values vᵤ⁺, vᵥ⁺, and v_{w}⁺ and the median value of the triangular wave is synchronized with the phase zero of the fundamental wave component of the first command values vᵤ⁺, vᵥ⁺, and v_{w}⁺ when the multiphase inverter circuit 3 is driven by the gate signal g generated using the carrier signal c, the generated phase voltage is positively and negatively symmetric in the phases of 0° to 180° and the phases of 180° to 360°, and is inversely symmetric in the phases of 0° to 90° and the phases of 90° to 180°. Therefore, the phase voltage does not include an even-order harmonic component or a cosine component, and the harmonic component included in the phase voltage is only the odd-order sine wave component. Therefore, by configuring the second command values mᵤ, mᵥ, and m_{w} with the fundamental wave components of the first command values vᵤ⁺, vᵥ⁺, and v_{w}⁺ and the harmonic components including at least one sine wave having a frequency of an odd multiple of the fundamental wave component, it is possible to reduce the harmonic components included in the output phase voltage. The frequency distribution of harmonics generated by switching of the multiphase inverter circuit 3 can be optimized with a relatively simple configuration. As a result, it is possible to effectively reduce frequency components that generate the noise and the torque pulsation of the load and to reduce the loss of the load due to the harmonic component at the same time.

Note that the harmonic components included in the second command values mᵤ, mᵥ, and m_{w} can include at least one sine wave having a frequency that is an odd multiple of the fundamental wave component of the first command values vᵤ⁺, vᵥ⁺, and v_{w}⁺, and not an integer multiple of the number of phases of the multiphase inverter circuit 3.

In addition, the modulation voltage generator 6A can store the second command values mᵤ, mᵥ, and m_{w} corresponding to ¼ cycles of the fundamental wave components of the first command values vᵤ⁺, vᵥ⁺, and v_{w}⁺ in the waveform storage device 605 and generate the second command values mᵤ, mᵥ, and m_{w}, using the waveform storage device 605. As described above, as the frequency of the carrier signal c is an odd multiple of the fundamental wave component of the first command values vᵤ⁺, vᵥ⁺, and v_{w}⁺, and the median value of the triangular wave is synchronized with the phase zero of the fundamental wave component of the first command values vᵤ⁺, vᵥ⁺, and v_{w}⁺, the generated phase voltage is positively and negatively symmetric in the phases of 0° to 180° and phases of 180° to 360°, and is inversely symmetric in the phases of 0° to 90° and phases of 90° to 180°. Therefore, as long as the second command values mᵤ, mᵥ, and m_{w} corresponding to ¼ cycles of the fundamental wave component are stored, it is possible to generate the second command values mᵤ, mᵥ, and m_{w} for one cycle by using the above features.

The frequency of the carrier signal c is a multiple of the frequency of the fundamental wave component, and this multiple can be an odd number and an integer multiple of the number of phases of the multiphase inverter circuit 3. As a result, the carrier signal c can be synchronized with the phase of the phase voltage of any phase, and the carrier signal c common to multiple phases can be used.

The modulation voltage generator 6A keeps the second command values mᵤ, mᵥ, and m_{w} constant in a carrier half cycle that is a period in which the carrier signal c changes from the minimum value to the maximum value or a period in which the carrier signal c changes from the maximum value to the minimum value. As a result, the number of values stored in the waveform storage device 605 can be reduced, and the required storage capacity can be reduced. Specifically, in the first embodiment, since Kc=9, ¼ cycles of the fundamental wave component correspond to 4.5 times the carrier half cycle, and the second command values mᵤ, mᵥ, and m_{w} are set to zero in the first 0.5 cycles, it is sufficient to optimize and store only the four second command values mᵤ, mᵥ, and m_{w}, and the optimization is easy.

Note that, as described above using Formula (4), in the power conversion device 1A, the second command values mᵤ, mᵥ, and m_{w} are optimized such that the effective current value of the load is lower than that in a case where the second command values mᵤ, mᵥ, and m_{w} do not include a harmonic component. At this time, the second command values mᵤ, mᵥ, and m_{w} are optimized such that the amplitudes of predetermined frequency components, for example, fifth and seventh harmonic components, are lower than those in a case where the second command values mᵤ, mᵥ, and m_{w} do not include a harmonic component by using the weighting coefficients expressed in Formula (5).

### Second Embodiment

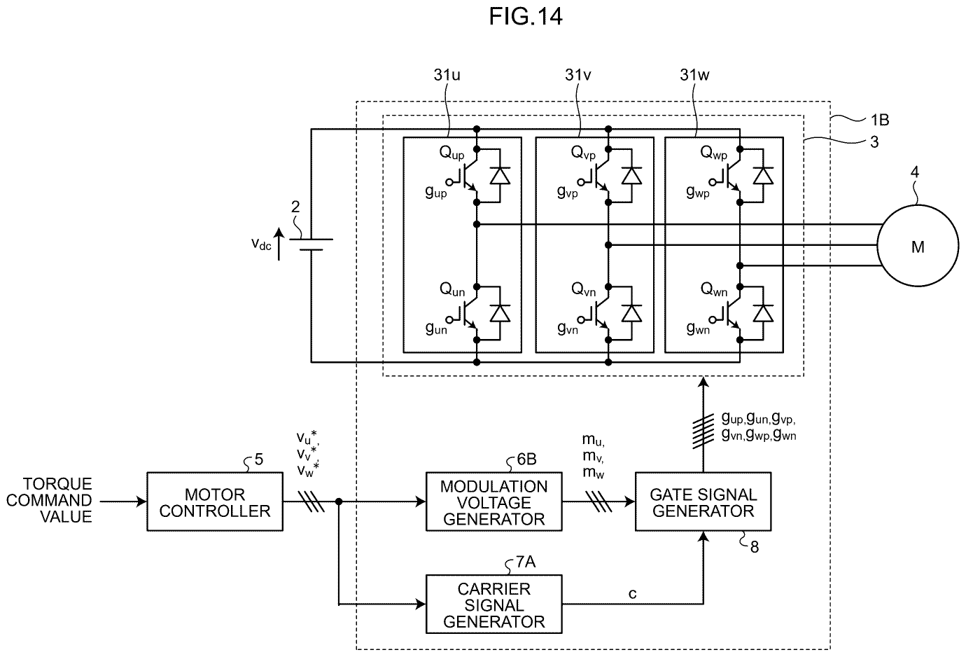

FIG. 14 is a diagram illustrating a configuration of a power conversion device 1B according to the second embodiment. The power conversion device 1B includes the multiphase inverter circuit 3, a modulation voltage generator 6B, the carrier signal generator 7A, and the gate signal generator 8. The power conversion device 1B includes the modulation voltage generator 6B instead of the modulation voltage generator 6A of the power conversion device 1A according to the first embodiment. Hereinafter, the description of parts common to the power conversion device 1A according to the first embodiment will be omitted, and differences from the power conversion device 1A will be mainly described.

In the phase synchronization control for synchronizing the carrier signal c with the phase of the phase voltage command value of the load, when the phase or frequency of the voltage to be supplied to the load changes transiently, an identification time for synchronizing the carrier signal c with the phase voltage command value is required. In the first embodiment, since the second command values mᵤ, mᵥ, and m_{w} are generated based on the phase of the carrier signal c, while the phase of the carrier signal c is not completely synchronized with the first command values vᵤ⁺, vᵥ⁺, and v_{w}⁺, the second command values mᵤ, mᵥ, and m_{w}, that is, the phase voltage of the load, is not synchronized with the first command value. Therefore, the modulation voltage generator 6B has a function capable of quickly generating the second command values mᵤ, mᵥ, and m_{w} synchronized with the first command values vᵤ⁺, vᵥ⁺, and v_{w}⁺ even when the phases and frequencies of the first command values vᵤ⁺, vᵥ⁺, and v_{w}⁺ change transiently.

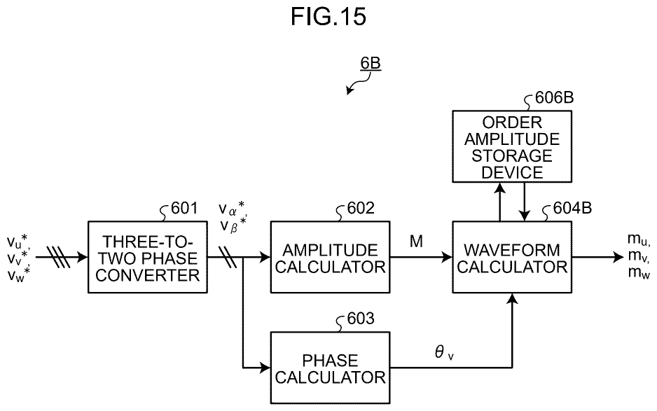

FIG. 15 is a diagram illustrating a configuration of the modulation voltage generator 6B illustrated in FIG. 14. The modulation voltage generator 6B includes the three-to-two phase converter 601, the amplitude calculator 602, the phase calculator 603, a waveform calculator 604B, and an order amplitude storage device 606B.

The modulation voltage generator 6B includes the waveform calculator 604B instead of the waveform calculator 604A of the modulation voltage generator 6A according to the first embodiment, and includes the order amplitude storage device 606B instead of the waveform storage device 605.

In the order amplitude storage device 606B, information of the optimized second command values mᵤ, mᵥ, and m_{w} is stored in advance. Specifically, for the amplitude M, the order amplitude storage device 606B stores the amplitude m₁ of the fundamental wave component of the second command values mᵤ, mᵥ, and m_{w}, the amplitude of the sine wave to be included as the harmonic component, and how many times the frequency of the sine wave to be included as the harmonic component is the fundamental wave component. Here, the harmonic components have frequencies that are three times, five times, and seven times the fundamental wave component, and amplitudes of m₃, m₅, and m₇, respectively. Note that m₁, m₃, m₅, and m₇ are stored in association with the respective values of the amplitude M, and the amplitude of the fundamental wave component with respect to the amplitude M is m₁ (M), and the amplitude of the sine wave with respect to the amplitude M is m₃ (M), m₅ (M), and m₇ (M). Here, the harmonic component in a case where the phase of the sine wave is 180° can be reproduced by setting the amplitude to a negative value.

In the second embodiment, the second command values mᵤ, mᵥ, and m_{w} as illustrated in FIG. 8 optimized in the same manner as in the first embodiment are used. In the first embodiment, four voltage command values for four sections of the carrier half cycle are stored in order to reproduce a waveform for ¼ cycles of the fundamental wave component. Since the degree of freedom is four, the original optimal waveform can be reproduced by using the fundamental wave component and the harmonic components of the three frequencies.

The waveform calculator 604B calculates waveforms of the second command values mᵤ, mᵥ, and m_{w} with respect to the amplitude M. For example, the u-phase second command value mᵤ (M) with respect to the amplitude M can be calculated using Formula (7) below.

$$Formula 7$$

$${m}_{u} ( M ) = {m}_{1} ( M ) sin {θ}_{v} + {m}_{3} ( M ) sin 3 {θ}_{v} + {m}_{5} ( M ) sin 5 {θ}_{v} + {m}_{7} ( M ) sin 7 {θ}_{v} \qquad ( 7 )$$

Since the waveforms of the three-phase second command values mᵤ, mᵥ, and m_{w} are waveforms in which the phases of the fundamental wave components are shifted from each other by 120°, the three-phase second command values mᵤ, mᵥ, and m_{w} can be generated using the u-phase fundamental wave phase θv.

As described above, according to the power conversion device 1B according to the second embodiment, since the second command values mᵤ, mᵥ, and m_{w} of the first embodiment are reproduced by function approximation, first, the same effects as those of the first embodiment can be obtained. Specifically, as in the first embodiment, it is possible to reduce the effective current value of the load, that is, the loss. In addition, it is possible to reduce and almost eliminate specific frequency components assumed to excite mechanical resonance of the load to cause large noise and torque pulsation, for example, fifth and seventh harmonic components.

In the power conversion device 1B according to the second embodiment, the modulation voltage generator 6B stores, in the order amplitude storage device 606B, i.e., a storage device, the amplitude m₁ of the fundamental wave component of the first command values vᵤ⁺, vᵥ⁺, and v_{w}⁺, the amplitude of the sine wave included in the harmonic component, and how many times the frequency of the sine wave included in the harmonic component is the fundamental wave component in the order amplitude storage device 606B as a storage device, and generates the second command values mᵤ, mᵥ, and m_{w}, using the order amplitude storage device 606B. Therefore, even while the phase and frequency of the first command values vᵤ⁺, vᵥ⁺, and v_{w}⁺ change transiently and the phase synchronization control of the carrier signal c cannot follow, the voltage according to the first command values vᵤ⁺, vᵥ⁺, and v_{w}⁺ can be supplied to the load. Therefore, the voltage to be supplied to the load can be controlled with high accuracy and high response.

Note that the carrier signal generator 7A generates the carrier signal c having a frequency that is nine times the fundamental wave component, and the second command values mᵤ, mᵥ, and m_{w} include sine waves of three frequencies as harmonic components. For example, the second command values mᵤ, mᵥ, and m_{w} can include sine waves having frequencies that are three times, five times, and seven times the fundamental wave component as harmonic components.

As described above, the power conversion device 1B according to the second embodiment can achieve a remarkable effect that the voltage to be supplied to the load can be controlled with high accuracy and high response, in addition to the effects of the first embodiment.

### Third Embodiment

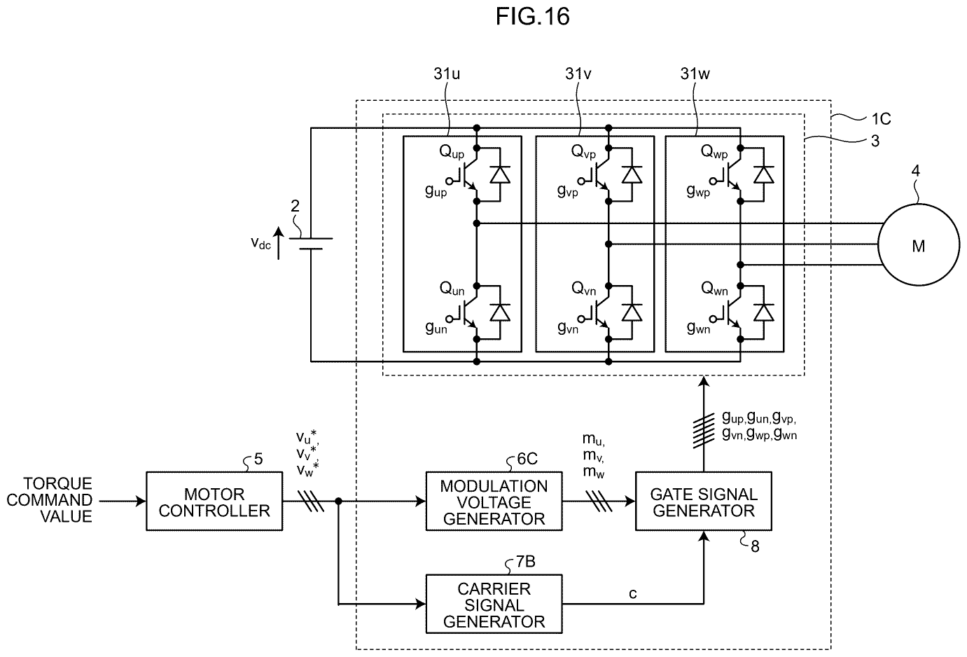

FIG. 16 is a diagram illustrating a configuration of a power conversion device 1C according to the third embodiment. The power conversion device 1C includes the multiphase inverter circuit 3, a modulation voltage generator 6C, a carrier signal generator 7B, and the gate signal generator 8. The power conversion device 1C includes the modulation voltage generator 6C instead of the modulation voltage generator 6A of the power conversion device 1A according to the first embodiment, and includes the carrier signal generator 7B instead of the carrier signal generator 7A. Hereinafter, the description of parts common to the power conversion device 1A according to the first embodiment will be omitted, and differences from the power conversion device 1A will be mainly described.

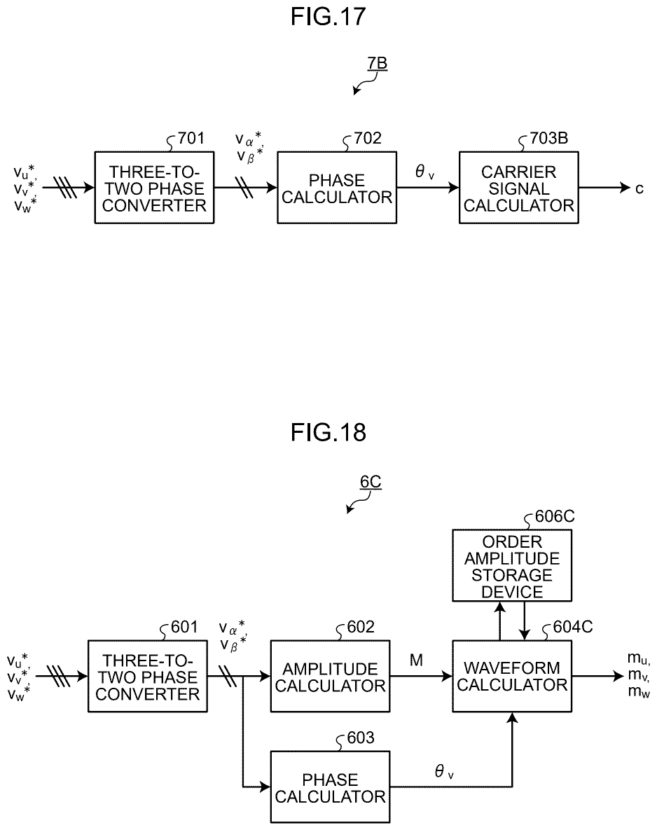

FIG. 17 is a diagram illustrating a configuration of the carrier signal generator 7B illustrated in FIG. 16. The carrier signal generator 7B includes the three-to-two phase converter 701, a phase calculator 702, and a carrier signal calculator 703B. The carrier signal generator 7B includes the carrier signal calculator 703B instead of the carrier signal calculator 703A of the carrier signal generator 7A according to the first embodiment.

The function of the carrier signal calculator 703B is basically similar to that of the carrier signal calculator 703A. The carrier signal calculator 703B differs from the carrier signal calculator 703A in setting an odd number Kc to 15 and generating a carrier signal c having a frequency that is 15 times the fundamental wave component. Regarding the phase synchronization control, the carrier signal generator 7B synchronizes the median value of the triangular wave, specifically, the phase of 270° of the carrier signal c, with the phase of 0° of the first command values vᵤ⁺, vᵥ⁺, and v_{w}⁺, similarly to the carrier signal generator 7A. In the third embodiment, as in the first embodiment, the carrier signal c is synchronized with the phase of the u-phase voltage, and the carrier signal c common to the three phases is used. Therefore, the odd number Kc for determining the frequency of the carrier signal c is set to a multiple of three that is the number of phases.

FIG. 18 is a diagram illustrating a configuration of the modulation voltage generator 6C illustrated in FIG. 16. The modulation voltage generator 6C includes the three-to-two phase converter 601, the amplitude calculator 602, the phase calculator 603, a waveform calculator 604C, and an order amplitude storage device 606C.

The modulation voltage generator 6C includes the waveform calculator 604C instead of the waveform calculator 604A of the modulation voltage generator 6A according to the first embodiment, and includes the order amplitude storage device 606C instead of the waveform storage device 605.

In the order amplitude storage device 606C, information of the optimized second command values mᵤ, mᵥ, and m_{w} is stored in advance. Specifically, for the amplitude M, the order amplitude storage device 606C stores the amplitude m₁ of the fundamental wave component of the second command values mᵤ, mᵥ, and m_{w}, the amplitude of the sine wave to be included as the harmonic component, and how many times the frequency of the sine wave to be included as the harmonic component is the fundamental wave component. Here, the harmonic components have six frequencies that are 3 times, 5 times, 7 times, 9 times, 11 times, and 13 times the fundamental wave component, and amplitudes of m₃, m₅, m₇, m₉, m₁₁, and m₁₃, respectively. Note that m₁, m₃, m₅, m₇, m₉, m₁₁, and m₁₃, are stored in association with the respective values of the amplitude M, and the amplitude of the fundamental wave component with respect to the amplitude M is m₁ (M), and the amplitude of the sine wave with respect to the amplitude M is m₃ (M), m₅ (M), m₇ (M), m₉ (M), m₁₁ (M), and m₁₃ (M). Here, the harmonic component in a case where the phase of the sine wave is 180° can be reproduced by setting the amplitude to a negative value.

The second command values mᵤ, mᵥ, and m_{w} are constant values in the carrier half cycle that is a period in which the carrier signal c changes from the minimum value to the maximum value or a period in which the carrier signal c changes from the maximum value to the minimum value. In addition, it is assumed that the waveforms of the second command values mᵤ, mᵥ, and m_{w} are positively and negatively symmetric in the phases of 0° to 180° and phases of 180° to 360°, and are inversely symmetric in the phases of 0° to 90° and phases of 90° to 180°. In the third embodiment, since the odd number Kc is set to 15, the fundamental wave ¼ cycle of the second command values mᵤ, mᵥ, and m_{w} corresponds to 7.5 times the carrier half cycle, but in order to maintain the symmetry of the phase voltage waveform, the second command values mᵤ, mᵥ, and m_{w} are set to zero in the first 0.5 cycles. Therefore, in the present embodiment, it is sufficient to optimize only seven values corresponding to seven sections of the carrier half cycle, and the optimization is easy. Since the degree of freedom of the waveforms of the second command values mᵤ, mᵥ, and m_{w} is seven, the original optimal waveform can be reproduced by using the fundamental wave component and the six harmonic components.

In the third embodiment, harmonic components included in the second command value are optimized so as to minimize the objective function f_{obj} expressed in Formula (8) below.

$$Formula 8$$

$${f}_{obj} = \sqrt{{\sum }_{i = 1}^{8} \{ {( {k}_{6 i - 1} \frac{{v}_{6 i - 1}}{6 i - 1} )}^{2} + {( {k}_{6 i + 1} \frac{{v}_{6 i + 1}}{6 i + 1} )}^{2} \}} \qquad ( 8 )$$

Here, the harmonic component is optimized so that the square root of the sum of squares of the value obtained by dividing the n-th harmonic voltage vn by the order n, that is, the effective current value of the load, is minimized. Here, n=6i±1. However, it is assumed that specific frequency components, here, 11th and 13th harmonic components, excite mechanical resonance of a load to cause large noise and torque pulsation, and weighting of these order components is increased to preferentially reduce the frequency components. That is, as expressed by Formula (9) below, the weight kₙ in Formula (8) is larger when n is 11 and when n is 13 than when n is other than 11 and 13. This makes it possible to reduce load loss while reducing noise and torque pulsation.

$$Formula 9$$

$${k}_{n} = \{ \begin{matrix}1 & ( n \neq 11 , 13 ) \\ 10 & ( n = 11 , 13 )\end{matrix} \qquad ( 9 )$$

In the present embodiment, the number of phases of the multiphase inverter circuit 3 and the motor 4 is set to three, and the three-phase waveforms are waveforms whose phases are shifted from each other by 120°, so that a harmonic component of a multiple of three is not generated. Furthermore, since the voltage waveform of each phase is positively and negatively symmetric in the phases of 0° to 180° and the phases of 180° to 360°, a harmonic component of a multiple of two is also not generated. In the optimization, harmonic components are considered up to the 50th order.

The waveform calculator 604C calculates the waveforms of the second command values mᵤ, mᵥ, and m_{w} based on the amplitude M and the fundamental wave phase θᵥ. For example, the u-phase second command value mᵤ (M) is calculated using Formula (10) below.

$$Formula 10$$

$${m}_{u} ( M ) = {m}_{1} ( M ) sin {θ}_{v} + {m}_{3} ( M ) sin 3 {θ}_{v} + {m}_{5} ( M ) sin 5 {θ}_{v} + {m}_{7} ( M ) sin 7 {θ}_{v} + {m}_{9} ( M ) sin 9 {θ}_{v} + {m}_{11} ( M ) sin 11 {θ}_{v} + {m}_{13} ( M ) sin 13 {θ}_{v} \qquad ( 10 )$$

Since the waveforms of the three-phase second command values mᵤ, mᵥ, and m_{w} are waveforms whose phases are shifted from each other by 120°, the waveform calculator 604C can generate the three-phase second command values mᵤ, mᵥ, and mᵥ using the u-phase fundamental wave phase θᵥ.

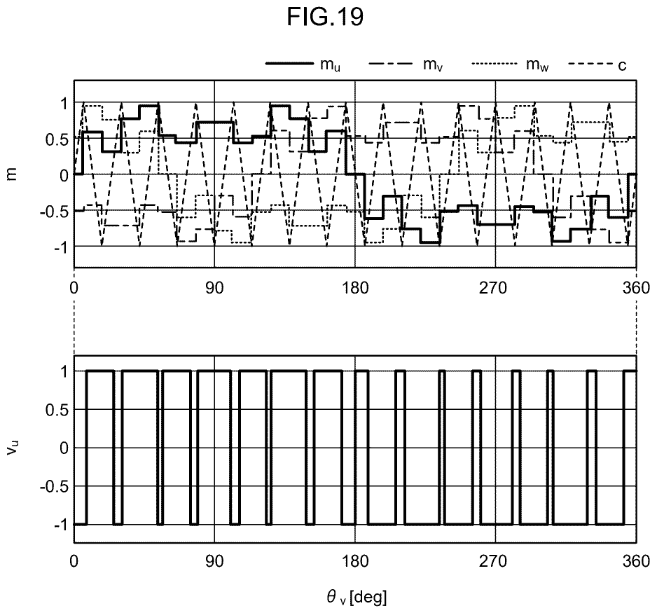

FIG. 19 is a diagram illustrating waveforms of the second command values mᵤ, mᵥ, and m_{w}, the carrier signal c, and the output phase voltage vᵤ according to the third embodiment. FIG. 19 illustrates a case where the amplitude M=0.8. The second command values mᵤ, mᵥ, and m_{w} include fundamental wave components of the first command values vᵤ⁺, vᵥ⁺, and v_{w}⁺ and harmonic components including odd-order sine wave components. Here, the harmonic component includes a sine wave component whose frequency is not an integral multiple of the number of phases.

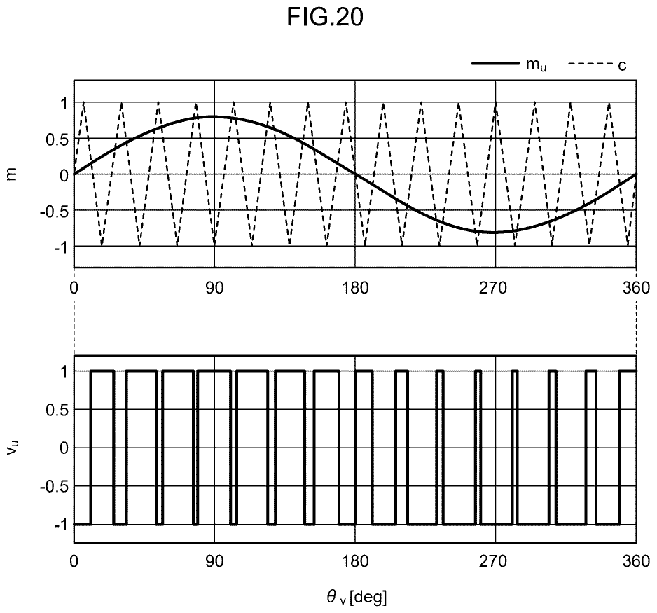

Here, in order to describe the effect of the power conversion device 1C according to the present embodiment, a comparative example using general carrier synchronization PWM will be described. FIG. 20 is a diagram illustrating waveforms of the phase voltage command value, the carrier signal c, and the output phase voltage vᵤ according to a comparative example of the third embodiment. The difference from the first embodiment illustrated in FIG. 19 is that no harmonic component is superimposed on the phase voltage command value. The same carrier signal c as that in the example illustrated in FIG. 19 is used.

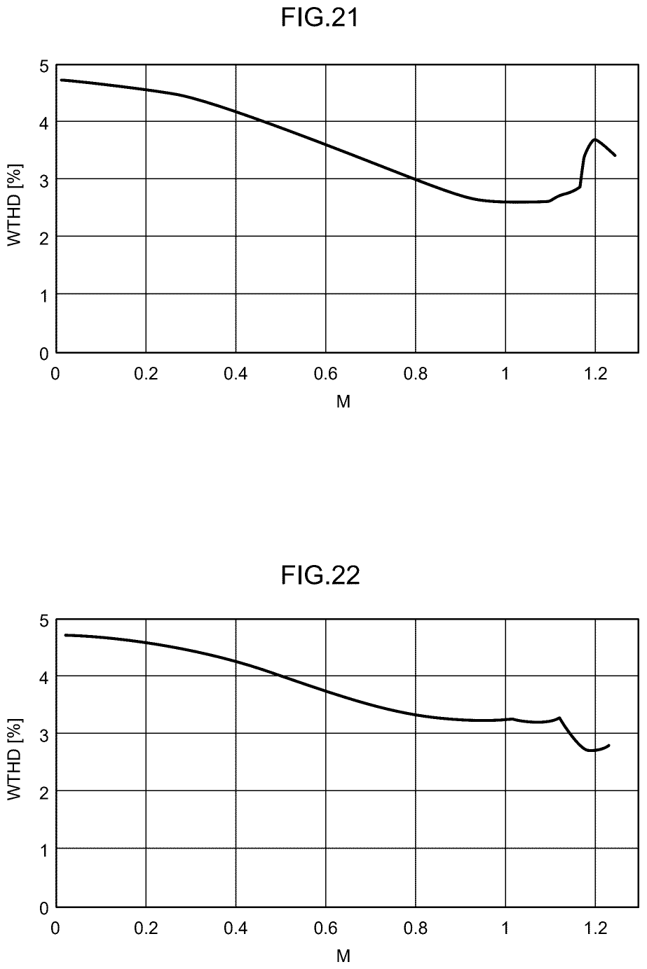

Here, the effective current value of the motor 4 as a load is evaluated by WTHD expressed by Formula (6) above. FIG. 21 is a diagram illustrating the WTHD of the power conversion device 1C according to the third embodiment. FIG. 22 is a diagram illustrating the WTHD in a comparative example of the third embodiment. Comparing FIG. 21 with FIG. 22, it can be confirmed that WTHD can be greatly reduced particularly in a region where the amplitude M of the modulation voltage is large, and the effective current value of the load, that is, the loss can be reduced. However, only in a portion where the amplitude M is close to the maximum value, the power conversion device 1C according to the third embodiment cannot reduce the WTHD as compared with the comparative example. This is because the 11th and 13th harmonic components are preferentially reduced although there is no degree of freedom to change the second command values mᵤ, mᵥ, and m_{w}.

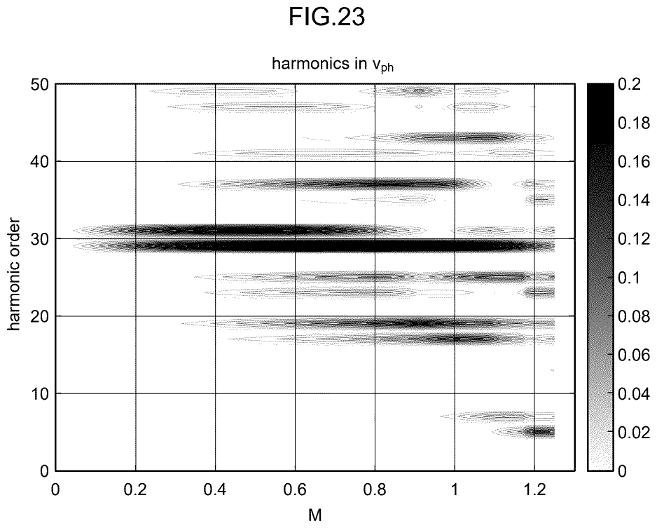

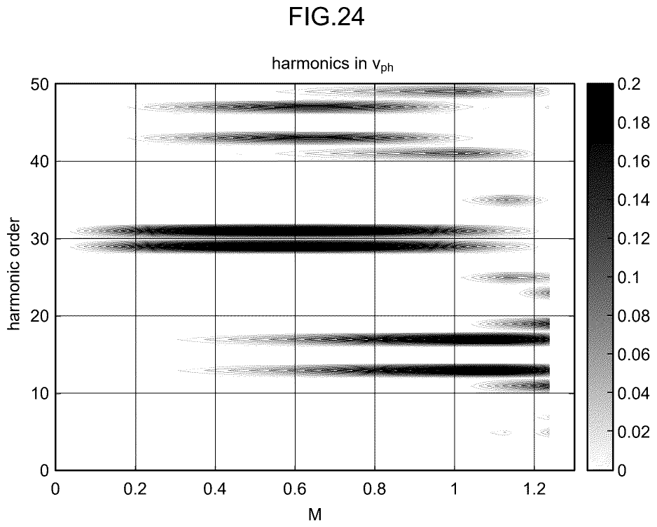

In addition, harmonic components included in the output phase voltage are compared between the power conversion device 1C according to the third embodiment and the comparative example. FIG. 23 is a diagram illustrating the magnitude of harmonic components included in the output phase voltage of the power conversion device 1C according to the third embodiment. FIG. 24 is a diagram illustrating the magnitude of harmonic components included in the output phase voltage in a comparative example of the third embodiment. In FIGS. 23 and 24, the horizontal axis represents the amplitude M, and the vertical axis represents the frequency of the harmonic wave expressed by the order with respect to the fundamental wave. In FIGS. 23 and 24, for the magnitude of the harmonic components, a value obtained by dividing the amplitude vₚₕ of the output phase voltage by half of the DC voltage is indicated by color shading. By comparing FIGS. 23 and 24, it can be seen that in the power conversion device 1C according to the third embodiment, it is possible to greatly reduce specific frequency components assumed to excite mechanical resonance of the load to cause large noise and torque pulsation, here, the 11th and 13th harmonic components. The amplitudes of the 11th and 13th harmonic components are several percent or less of the amplitude M which is the amplitude of the fundamental wave component, and it can be confirmed that the amplitudes are almost removed.

As described above, in the power conversion device 1C according to the third embodiment, the frequency of the carrier signal c is higher than that in the power conversion device 1A according to the first embodiment. However, even in such a case, the frequency distribution of harmonics generated by switching of the multiphase inverter circuit 3 can be optimized with a relatively simple configuration. As a result, the power conversion device 1C can achieve the same effects as those of the first embodiment. In the third embodiment, the modulation voltage generator 6C stores, in the order amplitude storage device 606C, the amplitude of the fundamental wave component, the amplitude of the sine wave included in the harmonic component, and how many times the sine wave included in the harmonic component is the fundamental wave component, and generates the second command values mᵤ, mᵥ, and m_{w}, using the order amplitude storage device 606C. Therefore, as in the second embodiment, even while the phase and frequency of the first command values vᵤ⁺, vᵥ⁺, and v_{w}⁺ change transiently and the phase synchronization control of the carrier signal c does not completely follow the first command values vᵤ⁺, vᵥ⁺, and v_{w}⁺ the voltage according to the first command values vᵤ⁺, vᵥ⁺, and v_{w}⁺ can be supplied to the motor 4 that is a load. Therefore, the voltage to be supplied to the motor 4 can be controlled with high accuracy and high response. In a case where the load is the motor 4 as in the present embodiment, the speed and torque of the motor 4 can be controlled with high accuracy and high response.

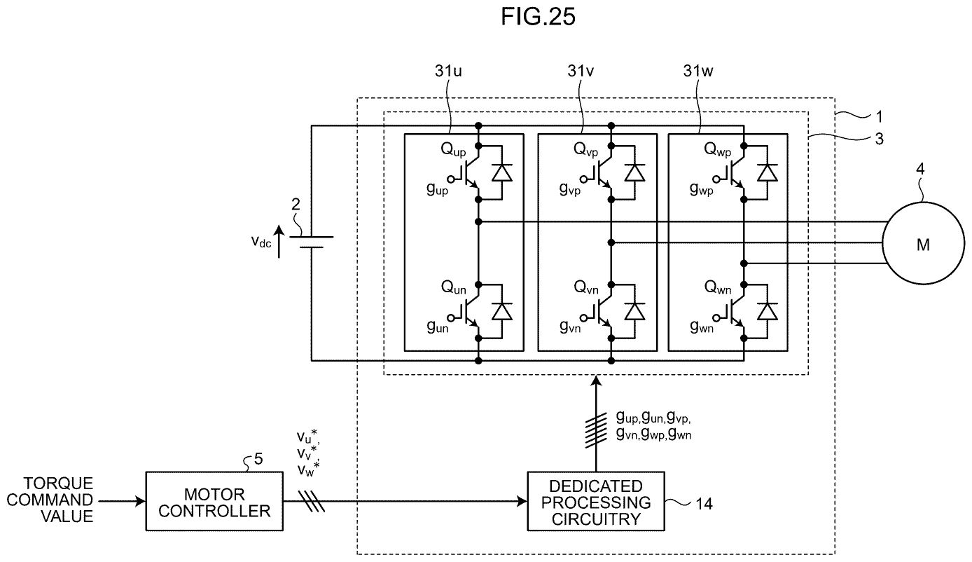

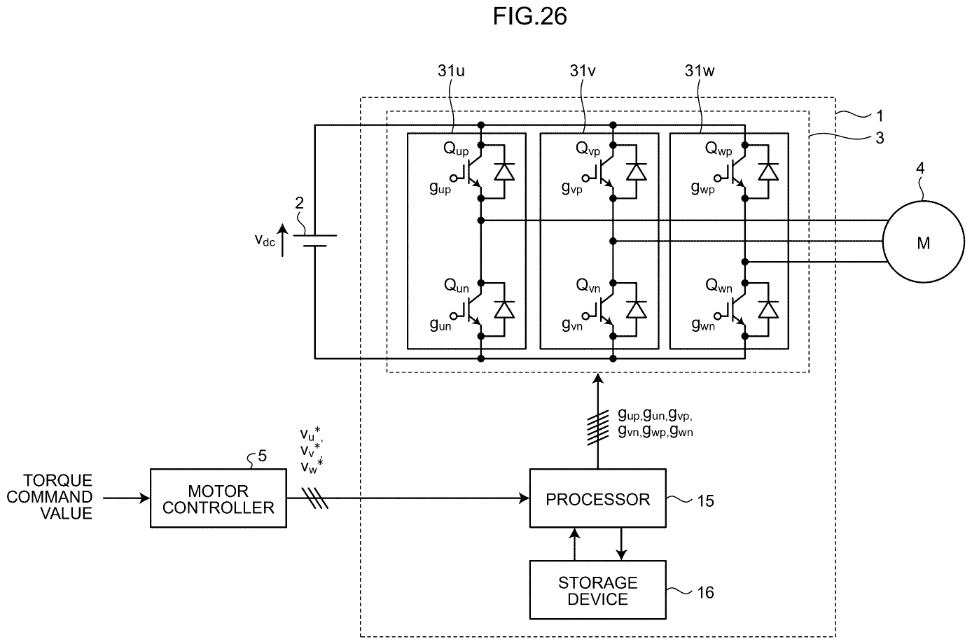

Here, hardware configurations of the power conversion devices 1A, 1B, and 1C according to the first to third embodiments will be described. Here, the power conversion devices 1A, 1B, and 1C are collectively referred to as the power conversion device 1. The functions of the power conversion device 1 can be implemented using processing circuitry. Here, the functions of the power conversion device 1 are the functions of the modulation voltage generators 6A, 6B, and 6C, the carrier signal generators 7A and 7B, and the gate signal generator 8. The processing circuitry may be dedicated hardware such as dedicated processing circuitry 14 illustrated in FIG. 25, or may be a processor 15 and a storage device 16 illustrated in FIG. 26.

FIG. 25 is a diagram illustrating an exemplary configuration of the power conversion device 1 using dedicated hardware. In a case where dedicated hardware is used, the dedicated processing circuitry 14 is a single circuit, a composite circuit, a programmed processor, a parallel programmed processor, an application specific integrated circuit (ASIC), a field programmable gate array (FPGA), or a combination thereof. Each of the plurality of functions of the power conversion device 1 described above may be implemented by different pieces of the dedicated processing circuitry 14, or the plurality of functions of the power conversion device 1 may be collectively implemented by the dedicated processing circuitry 14.

FIG. 26 is a diagram illustrating an exemplary configuration of the power conversion device 1 using a processor and a storage device. In a case where the processor 15 and the storage device 16 are used, the above functions of the power conversion device 1 are implemented by software, firmware, or a combination thereof. Software and firmware are described as programs, and the processor 15 reads and executes the programs stored in the storage device 16. It can also be said that these programs cause a computer to execute the procedures and methods for the functions of the power conversion device 1.

The processor 15 is a central processing unit (CPU), and is also called a processing device, an arithmetic device, a microprocessor, a microcomputer, a digital signal processor (DSP), or the like. The storage device 16 is, for example, a nonvolatile or volatile semiconductor memory such as a read only memory (ROM), an erasable programmable ROM (EPROM), or an electrically EPROM (EEPROM (registered trademark)), a flexible disk, an optical disc, a compact disc, a digital versatile disk (DVD), or the like. In addition, some of the plurality of functions of the power conversion device 1 may be implemented by dedicated hardware, and the others may be implemented by using software or firmware.

The configurations described in the above-mentioned embodiments indicate examples. The embodiments can be combined with another well-known technique and with each other, and some of the configurations can be omitted or changed in a range not departing from the gist.

For example, in the above embodiments, the multiphase inverter circuit 3 is a three-phase inverter circuit. However, the multiphase inverter circuit 3 may be an inverter circuit having a different number of phases, or various inverter circuits such as a multi-level inverter exemplified by a 3-level inverter or a 5-level inverter can be used.

In the above embodiments, when the median value of the triangular wave that is the carrier signal c is synchronized with the phase of 0° of the first command values vᵤ⁺, vᵥ⁺, and v_{w}⁺, the carrier signal generators 7A and 7B use the median value on the rising side of the triangular wave, which is the phase of 270° in the example of FIG. 3. However, the carrier signal generators 7A and 7B may synchronize the median value on the decreasing side of the triangular wave, that is, the phase of 90° in the example of FIG. 3, with the phase of 0° of the first command values vᵤ⁺, vᵥ⁺, and v_{w}⁺.

Further, in the above embodiments, the carrier signal generators 7A and 7B generate the common carrier signal c in all the phases, but the carrier signal c for each phase may be prepared.

In the above embodiments, the second command values mᵤ, mᵥ, and m_{w} are constant in the carrier half cycle in which the carrier signal c changes from the minimum value to the maximum value or from the maximum value to the minimum value. However, in a case where a high-speed arithmetic device can be used, smoother second command values mᵤ, mᵥ, and m_{w} updated at a sufficiently short cycle with respect to the carrier signal c may be used.

In the above embodiments, only an odd-order sine wave component is superimposed on the fundamental wave component with respect to the second command values mᵤ, mᵥ, and m_{w} which are phase voltage command values for modulation obtained by dividing the first command values vᵤ⁺, vᵥ⁺, and v_{w}⁺ by half of the DC voltage v_{dc}, so that the second command values mᵤ, mᵥ, and m_{w} including the fundamental wave component and a harmonic component including at least one sine wave having a frequency of an odd multiple of the fundamental wave component are generated, and the waveforms of the second command values mᵤ, mᵥ, and m_{w} are optimized. However, only the odd-order sine wave component may be superimposed on the fundamental wave component with respect to the first command values vᵤ⁺, vᵥ⁺, and v_{w}⁺ which are original phase voltage command values.

In the first and second embodiments, the fifth and seventh harmonic components are preferentially reduced as specific frequency components, and in the third embodiment, the 11th and 13th harmonic components are preferentially reduced. As described above, considering the symmetry of the voltage waveform, a harmonic component of an integral multiple of the number of phases or an even-order harmonic component is not generated. Given that k is an integer, harmonic components in the case of the three phases can be expressed as (6k±1)-th harmonic components. In addition to those exemplified above, it is possible to preferentially reduce a component freely selected from the (6k±1)-th harmonic components.

### REFERENCE SIGNS LIST

1, 1A, 1B, 1C power conversion device; 2 DC power supply; 3 multiphase inverter circuit; 4 motor; 5 motor controller; 6A, 6B, 6C modulation voltage generator; 7A, 7B carrier signal generator; 8 gate signal generator; 14 dedicated processing circuitry; 15 processor; 16 storage device; 31, 31u, 31v, 31w leg; 601, 701 three-to-two phase converter; 602 amplitude calculator; 603, 702 phase calculator; 604A, 604B, 604C waveform calculator; 605 waveform storage device; 606B, 606C order amplitude storage device; 703A, 703B carrier signal calculator.

1. A power conversion device to supply power to a multiphase load based on a first command value, the first command value being a sinusoidal phase voltage command value, the power conversion device comprising:
a multiphase inverter circuit in which legs each including two series-connected semiconductor switching elements having reverse conduction functions are connected in parallel between positive and negative terminals of a DC power supply, the number of the legs being equal to the number of phases, and a terminal between the two semiconductor switching elements in each of the plurality of legs is connected to each phase of the load;
modulation voltage generation circuitry to generate a second command value, the second command value being a phase voltage command value for modulation and including a fundamental wave component of the first command value and a harmonic component including at least one sine wave having a frequency that is an odd multiple of the fundamental wave component;
carrier signal generation circuitry to generate a carrier signal of a triangular wave having a frequency that is an odd multiple of the fundamental wave component of the first command value, the triangular wave having a median value synchronized with a phase zero of the fundamental wave component of the first command value; and
gate signal generation circuitry to generate agate signal for driving the semiconductor switching elements in accordance with a result of comparison between the second command value and the carrier signal.

2. The power conversion device according to claim 1, wherein
the harmonic component included in the second command value includes at least one sine wave having a frequency that is an odd multiple of the fundamental wave component of the first command value, and not an integer multiple of the number of phases of the multiphase inverter circuit.

3. The power conversion device according to claim 1, wherein
the modulation voltage generation circuitry stores, in a storage device, the second command value corresponding to ¼ cycles of the fundamental wave component of the first command value, and generates the second command value, using the storage device.

4. The power conversion device according to claim 1, wherein
the modulation voltage generation circuitry stores, in a storage device, an amplitude of the fundamental wave component, an amplitude of a sine wave included in the harmonic component, and how many times a frequency of the sine wave included in the harmonic component is the fundamental wave component, and generates the second command value, using the storage device.

5. The power conversion device according to claim 1, wherein
the carrier signal generation circuitry generates the carrier signal having a frequency that is nine times the fundamental wave component, and
the harmonic component includes sine waves of three frequencies.

6. The power conversion device according to claim 5, wherein
the harmonic component includes sine waves having frequencies that are three times, five times, and seven times the fundamental wave component.

7. The power conversion device according to claim 1, wherein
the carrier signal generation circuitry generates the carrier signal having a frequency that is 15 times the fundamental wave component, and
the harmonic component includes sine waves of six frequencies.

8. The power conversion device according to claim 7, wherein
the harmonic component includes sine waves having frequencies that are 3 times, 5 times, 7 times, 9 times, 11 times, and 13 times the fundamental wave component.

9. The power conversion device according to claim 1, wherein
the frequency of the carrier signal is a multiple of the fundamental wave component, the multiple being an odd number and an integer multiple of the number of phases of the multiphase inverter circuit.

10. The power conversion device according to claim 1, wherein
the modulation voltage generation circuitry keeps the second command value constant in a carrier half cycle that is a period in which the carrier signal changes from a minimum value to a maximum value or a period in which the carrier signal changes from a maximum value to a minimum value.

11. The power conversion device according to claim 1, wherein
an effective current value of the load is lower than that in a case where the second command value does not include the harmonic component.

12. The power conversion device according to claim 1, wherein
an amplitude of a predetermined frequency component included in a phase voltage of the load is lower than that in a case where the second command value does not include the harmonic component.

13. A method for controlling a power conversion device to supply power to a multiphase load based on a first command value, the first command value being a sinusoidal phase voltage command value, the power conversion device having a multiphase inverter circuit in which legs including two series-connected semiconductor switching elements having reverse conduction functions are connected in parallel between positive and negative terminals of a DC power supply, the number of the legs being equal to the number of phases, and a terminal between the two semiconductor switching elements in each of the plurality of legs is connected to each phase of the load, the method comprising:
generating a second command value, the second command value being a phase voltage command value for modulation and including a fundamental wave component of the first command value and a harmonic component including at least one sine wave having a frequency that is an odd multiple of the fundamental wave component;
generating a carrier signal of a triangular wave having a frequency that is an odd multiple of the fundamental wave component of the first command value, the triangular wave having a median value synchronized with a phase zero of the fundamental wave component of the first command value; and
generating a gate signal for driving the semiconductor switching elements in accordance with a result of comparison between the second command value and the carrier signal.
